(19) United States
(12) Patent Application Publication
(10) Pub. No.: US 2005/0207538 A1
(43) Pub. Date: Sep. 22, 2005

(54) Method of determining an image from an image sequence

(76) Inventors: Sabine Mollus, Aachen (DE); Ingo Stuke, Luebeck (DE); Kai Eck, Aachen (DE); Til Aach, Lubeck (DE)

Correspondence Address: PHILIPS INTELLECTUAL PROPERTY & STANDARDS, P.O. BOX 3001, BRIARCLIFF MANOR, NY, 10510, US

(21) Appl. No.: 10/509,457

(22) PCT Filed: Apr. 1, 2003
(86) PCT No.: PCT/IB03/01183

§ 371 Date: May 2, 2005

(30) Foreign Application Priority Data
Apr. 3, 2002 (DE) 102 14 763.9

(51) Int. Cl. H01J 35/10; H01J 35/24; H01J 35/28

(52) U.S. Cl. 378/132

(57) ABSTRACT

The invention relates to a method of determining a corresponding image of a moving object for a reference image from an image sequence which represents the motion as a sequence of states of motion. To this end, two motion signals, representing the development of the relevant motions, are examined for similarities. Using the similarity function thus obtained, that image in the image sequence can be determined which represents at least approximately the state of motion of the object which is represented in the reference image. Furthermore, the invention relates to a system which is suitable for carrying out the method as well as to a computer program and a computer program product enabling a data processing unit to carry out the method.

The invention relates to a method of determining a corresponding image for a reference image from an image sequence of a moving object, the image sequence representing the object motion as a sequence of states of motion. The invention also relates to a system and to an examination apparatus whereby the method can be carried out as well as to a computer program and a computer program product enabling a data processing unit to carry out the method.

The method is used, for example, wherever an image of a state of motion is to be determined in an image sequence, said state of motion also being represented in a reference image acquired during a second, similar motion of the object. While the object performs the motions, each time a signal is determined which represents the sequence in time of the states of motion for each motion. Apparatus of this kind are known, for example, from the medical field. The patent document U.S. Pat. No. 4,729,379 discloses an X-ray examination apparatus for cardiological examinations in which two X-ray image sequences of the beating heart are acquired. A contrast medium is injected into the blood vessels of the heart during the acquisition of one of the two sequences.

During a subsequent step, the two sequences are subtracted from one another, that is, one image after the other, so that only the vessels filled with the contrast medium are reproduced with a minimum amount of background in the resultant differential sequence. To this end, the two image sequences must be aligned relative to one another in such a manner that from each image sequence always those images are subtracted which represent the same state of motion. This is achieved by the acquisition of a respective electrocardiographic (ECG) signal by means of an electrocardiograph, that is, in parallel with the acquisition of the two image sequences. In both ECGs each time two successive R deflections are determined whereby the two ECGs are aligned relative to one another. If the time elapsing between the two R deflections in the two ECGs differs, this time difference is compensated by linear interpolation, so that the images acquired between the R deflections of the two associated image sequences can be associated with one another.

Because only one reference instant is used for cardiac cycle, the image sequences are aligned with one another at one instant only, so that differences between the two ECG signals in respect of the duration of the overall cardiac cycle on the one hand and in respect of the expansion or compression of individual segments of the motion of the heart on the other hand are not taken into account. This gives rise to undesirable and disturbing artefacts in the differential sequence.

Therefore, it is an object of the present invention to improve systems of the kind set forth.

The object is achieved in accordance with the invention by means of a method of determining a corresponding image for a reference image from an image sequence of a moving object by means of a first and a second motion signal, in which
the first and the second motion signal represent the respective variation in time of the states of motion of a first motion and a second motion of the object,
the image sequence represents the first motion of the object as a sequence of images of states of motion,
the reference image represents a state of motion from the second object motion and is acquired at a reference instant during the second motion of the object,
   including the following steps:
a. determining a similarity function by way of a similarity comparison of the first and the second motion signal,
b. determining a correspondence instant in the first motion signal by means of the similarity function, the correspondence instant corresponding to the acquisition instant of the reference image from the second motion signal,
c. determining, using the first motion signal, that image of the image sequence whose acquisition instant corresponds at least approximately to the correspondence instant.

The above method serves to determine a corresponding image for a reference image, the corresponding image representing at least approximately that state of motion of a moving object which is represented in a reference image. From a first motion of an object there is now acquired an image sequence in which each image represents a state of motion of the object motion. The succession of images then represents a motion image sequence of the object motion. While the object performs a second motion, a reference image is acquired of a state of motion which occurs during the second motion of the object. A motion signal which characterizes or represents the variation in time of the states of motion of the motion is available from the first as well as from the second motion. A signal of this kind is, for example, an ECG which can be acquired while the relevant motion takes place. Another motion signal is a signal produced by a breathing sensor during the respiratory motion of a patient.

During a first step of the method the two motion signals are examined for similarities. This yields a similarity function which can be used to associate with any instant of one motion signal a corresponding instant of the other motion signal in such a manner that the object has assumed at least approximately the same state of motion at the two instants. Using the similarity function, in two motions there can be determined two instants at which the object has assumed approximately the same state of motion during the respective motions. Even when the motions differ to such an extent that the motion signals of the motions are non-linearly distorted relative to one another, as opposed to known methods, the method in accordance with the invention still produces results that are suitable for evaluation.

During a second step of the method the instant in the first motion signal which corresponds to the reference instant of the second motion signal is determined. In a third step of the method, that image of the image sequence whose acquisition instant corresponds approximately to the corresponding instant is determined as the corresponding image. The corresponding image thus selected represents at least approximately that state of motion of the moving object which is represented in the reference image. When the reference image and the corresponding image from the image sequence are subtracted from one another, the subtraction image will exhibit only a very small number of artifacts which may be due to the fact that two images of different states of motion are subtracted from one another.

In conformity with claim 2, the similarity comparison can be performed by means of the known “dynamic time warping” method. This method enables a very fast and efficient execution of the similarity comparison.

If the object motion is known in principle, so that additionally information can be provided on the states of motion assumed by the object between the acquisitions of the images of the image sequence, artificial intermediate images can be formed for these states of motion by interpolation. For example, the motions performed by some organs during respiration can be sufficiently accurately described by means of a motion model. In conformity with claim 3 it is then possible to form an image which represents as well as possible the state of motion assumed by the object during the acquisition of the reference image. This is advantageous notably when the difference between the actual instants of acquisition of the images of the image sequence and the correspondence instant is so large that too many artefacts are produced, for example, in a subtraction image. The interpolation of intermediate images can also be advantageously used when only few images can be acquired for the image sequence during the object motion.

In conformity with claim 4 the method can be used particularly advantageously in systems in which images and image sequences of a human or animal heart are formed and, moreover, an ECG of the cardiac motion is available. The method in accordance with the invention provides reliable determination of images representing the same state of motion of the heart notably in the case of patients who, because of disease or given physical conditions, have cardiac cycles whose ECGs exhibit non-linear distortions relative to one another.

In conformity with claim 5, the method is used in systems in which subtraction angiography is carried out. Imaging methods which are suitable for the acquisition of images of states of motion of the heart may be X-ray systems in conformity with claim 6 and ultrasound systems in conformity with claim 7. However, imaging systems which produce slice images or volume images, such as magnetic resonance tomography apparatus or X-ray computed tomography apparatus, will in the very near future also be capable of recording states of motion of the heart. The method can then be used accordingly.

Therefore, in conformity with claim 8 it is particularly advantageous to use the method in a system which comprises a data processing unit of the kind used in contemporary imaging systems in the medical field. An X-ray examination system may be provided with such a system in accordance with claim 9. If the data processing unit is constructed so as to be programmable, a computer program or computer program product as claimed in claim 10 can enable the data processing unit to carry out the method in accordance with the invention.

Embodiments of the invention will be described in detail hereinafter with reference to the Figures.

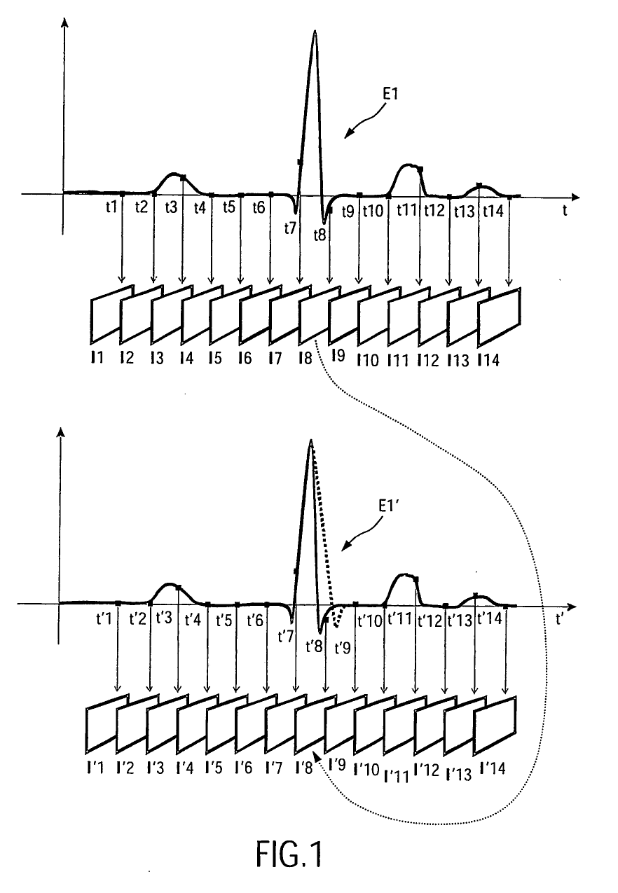

FIG. 1 is a diagrammatic representation of two ECGs in combination with image acquisitions.

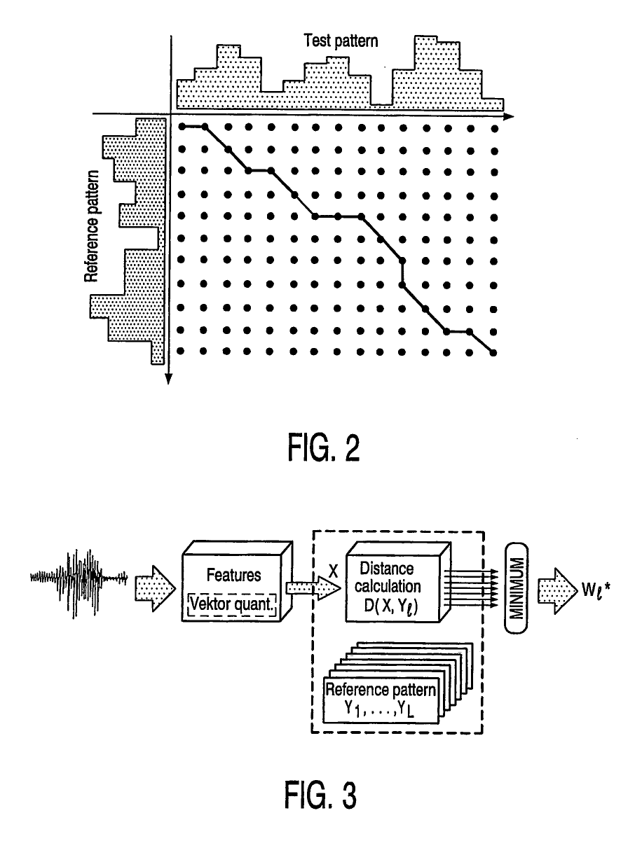

FIG. 2 shows a general method for the similarity comparison of two signals.

FIG. 3 shows the comparable task setting in speech recognition.

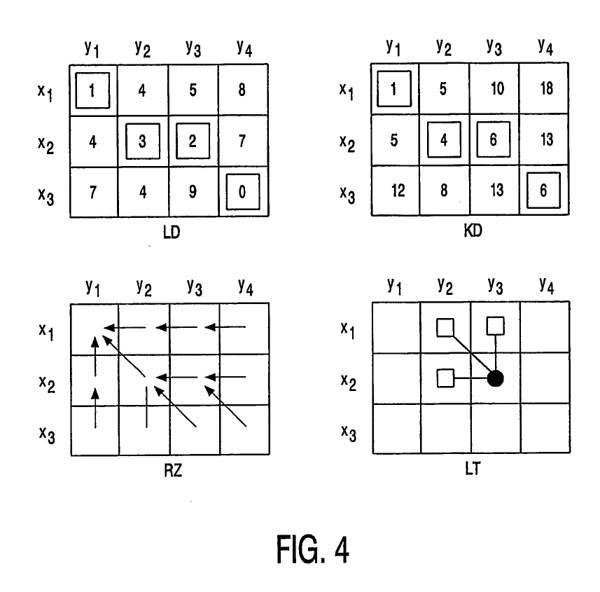

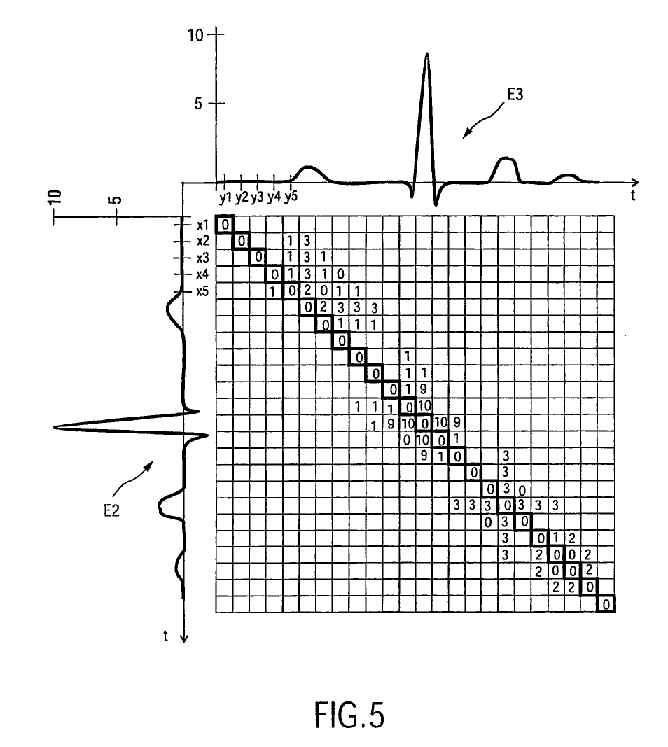

FIG. 4 shows, by way of example, local and cumulative distances as well as the relevant recursion matrix.

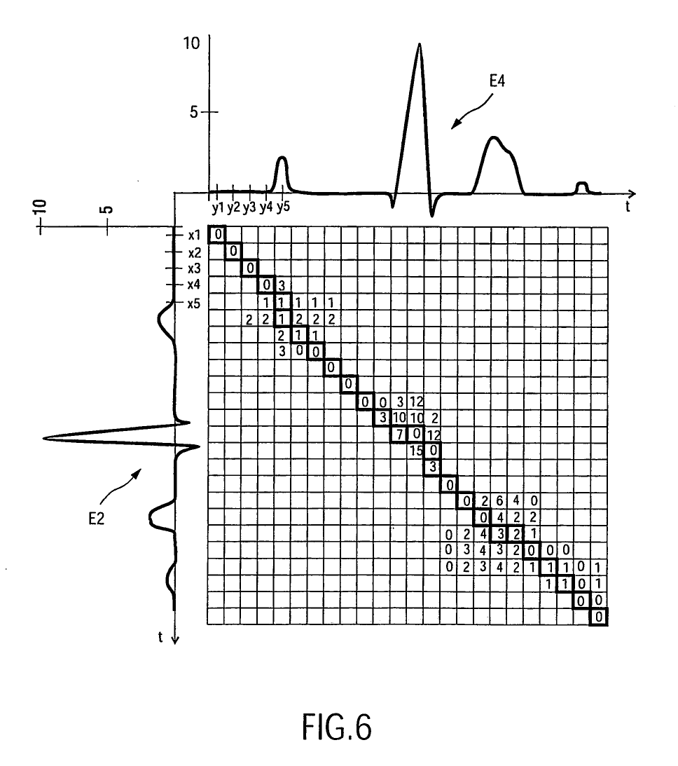

FIG. 5 and FIG. 6 show respective diagrams of some local distances for different ECGs.

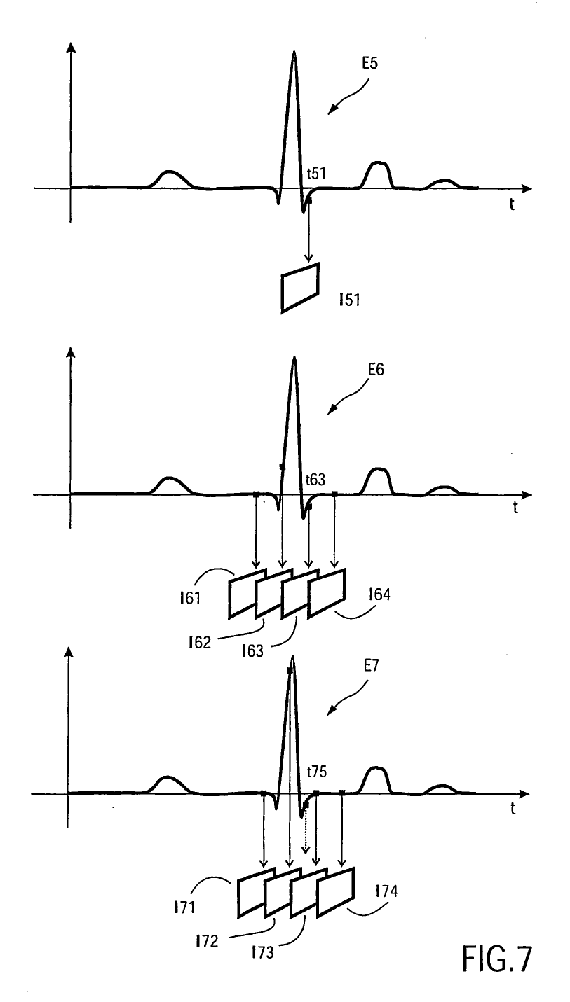

FIG. 7 illustrates the determination of a correspondence image.

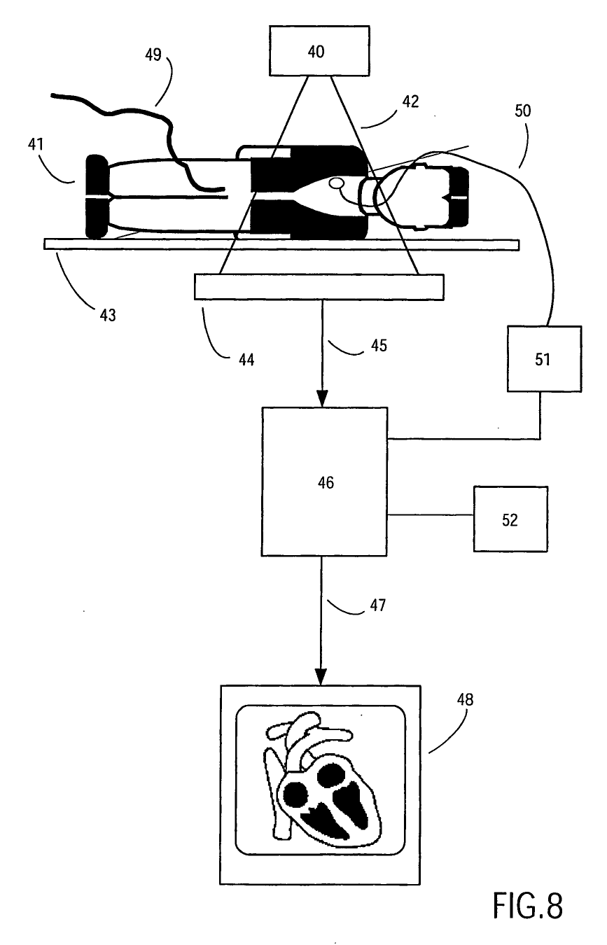

FIG. 8 shows an X-ray examination system.

FIG. 1 is a diagrammatic representation of an electrocardiogram (ECG) E1 of a cardiac cycle over the time t. Electrocardiography is a method of recording the action currents of the human or animal heart. The excited cardiac muscle location has an electric charge relative to the non-excited location; this charge propagates at a given speed through the remaining segments of the cardiac muscle. Such currents can be measured in time in known manner by means of suitable electrodes attached to the body and can be reproduced in conformity with FIG. 1. The typical duration of a human cardiac cycle is approximately one second.

During the cardiac cycle respective images I1 to I14 of the heart are acquired at a plurality of instants t1 to t14. Each of the images I1 to I14 represents a state of motion of the heart as an instantaneous image of the very complex cardiac motion. Images of this kind can be acquired by means of known imaging methods, for example, by means of X-ray imaging or ultrasound imaging. Contemporary X-ray systems enable the acquisition of a maximum of from 30 to 60 images per second, so that the images of the image sequence of a cardiac cycle represent 30 and 60 different states of motion of the heart, respectively. Such a number of images, however, is difficult to represent in the Figures, so that a smaller number is used herein.

For some examinations of the heart it is useful to image only the vascular tree of the blood vessels of the heart. To this end, a first and a second image are acquired of a state of motion of the heart. During the acquisition of the second image, for example, a contrast medium which absorbs X-rays is introduced into the blood vessels of the heart, for example, by means of a catheter, so that the blood vessels are highlighted very well in the X-ray system. The acquisition of the first image takes place without contrast medium. During a next step, both images are subtracted from one another, for example, one pixel after the other, so that in the ideal case only the vascular tree filled with contrast medium is still visible. This method is also referred to as subtraction angiography; in the case of digital images it is also called digital subtraction angiography (DSA). FIG. 1 illustrates diagrammatically the formation of a second image sequence during which the cardiac vessels are filled with a contrast medium, as well as the corresponding ECG E1′ of the cardiac cycle. The images I′1 to I′14 are acquired at the instants t′1 to t′14.

An image produced by DSA contains particularly few artefacts when the image elements or pixels to be removed by the subtraction are substantially the same in the two images. Furthermore, the shape of the object to be highlighted in the two images should also be substantially the same. Therefore, notably in the case of a complex motion such as the motion of the heart it is important to subtract two images from one another which represent the same state of motion of the heart as well as possible. For example, if the state of motion represented in the image I8 is to be represented as a DSA image, it is necessary to find from the second image sequence the image I′8 which represents substantially the same state of motion of the heart as the image I8. This is denoted by the dotted line. If, like in systems used thus far, exclusively the so-called R deflection (pronounced deflection briefly before the instant of acquisition of I8) is taken as a reference instant and if this deflection is substantially wider in the ECG E′1 than in the ECG E1 (dashed part of the ECG E1′), a known method would produce an image I′8 which is still situated in the descending part of the R deflection, so that it represents a state of motion completely other than the actually searched I′8. Notably in the case of patients suffering from cardiac disease it cannot be assumed simply that the curve of the ECG of two different cardiac cycles is exactly the same. Generally speaking, one ECG exhibits non-linear distortions relative to the other ECG, so that at a given instant during the acquisition of one ECG the heart is in a state of motion which differs from that during the acquisition of the other ECG. This makes the comparison of two ECGs for the determination of the image I′8 corresponding to the image I8 more difficult.

FIG. 2 is a general representation of a feasible method enabling two temporally non-linearly distorted signals to be examined in respect of similarity. The (one-dimensional) functions, plotted horizontally and vertically, correspond to two approximately the same functions. The different temporal structuring of the two functions becomes manifest in the relative distortion of their time scale. A supposed association of instants of corresponding events, such as states of motion, is marked as a path in the product grid of the scale.

The use of such pattern comparison algorithms is known from word recognition systems utilized in the field of speech recognition (for example, from the book by E. G. Schukat-Talamazzini “Automatische Spracherkennung”, ISBN 3-528-05492-1, Vieweg Verlag, 1995, Chapter 5.1). In conformity with FIG. 3 there is given a vocabulary Y=Y₁ . . . Y_{T}, each entry of the vocabulary being represented by a reference pattern Yₗ (also called a prototype or template) and each reference pattern Yₗ being given in the form of a feature vector sequence Yₗ=yₗ₁ . . . y_{lS}. A vocabulary entry forms a selected realization of the words which have been acquired during the system dimensioning phase. Furthermore, a short-term analyzed word is given in the form of the feature vector sequence X=x₁ . . . x_{T}. The task of recognizing individual words consists in determining the identity of the supposedly spoken word from the vocabulary by examining which word of the vocabulary corresponds best to the actually spoken word.

The distance D(X, Y) between the input sequence X=x₁ . . . x_{T} and a reference sequence Y=y₁ . . . y_{S} of different duration S≠T is determined as the sum of local distances dᵢⱼ=d(xᵢ, yⱼ) along a suitable time warping path between the vector sequences. The local distance function d(•,•) is realized, for example, by the Euclidean metric. The appropriate distortion function for this purpose should map X on Y over its entire length, satisfy given properties of monotony and constancy in the t scale and the s scale and yield the smallest overall distance. This very complex discrete optimization task (the number of combinatorily feasible paths increases exponentially as a function of the length of the prototype even when said limitations are imposed) satisfies the principle of optimization and hence can be solved by means of the generally known “dynamic programming” method. The cumulative distances Dᵢⱼ=D(x₁ . . . xᵢ, y₁ . . . yⱼ) between initial segments of the vector sequences X, Y are subject to the recursion formulas:

$${D}_{ij} = \{ \begin{matrix}0 & i = j = 0 \\ min \{ {D}_{i - 1 , j - 1} , {D}_{i - 1 , j} , {D}_{i , j - 1} \} + {d}_{ij} & i > 0 , j > 0 \\ ∞ & else\end{matrix}$$

Therefore, the overall distance D(X, Y)=D_{TS} can be determined by carrying out merely O(T·S) arithmetic operations. FIG. 4 shows the matrices of the local distances LD and the cumulative distances KD for a simple example. The optimum distortion path, that is, the path with a minimum distance, is highlighted by the squares enclosed by heavy lines. It can be determined by the setting of pointers in a recursion matrix RV in conformity with the above minimum decision in the recursion formula, that is, simultaneously with the overall distance. The number and shape of the terms in the minimum expression of the recursion formula are dependent on the permitted local transitions LT of the distortion function. In addition to the structure chosen in the example, many other modified path restrictions are known. This known algorithm for the time-elastic distance calculation is referred to as dynamic time warping (DTW).

This method enables two ECG curves to be compared for similarities. To this end, the ECG curves are presented in digital form, that is, represented by a large number of characteristic points (for example, 300) in each curve; this can be realized in known manner by sampling the ECG signal. The ECG curves thus form a sequence of scalars. The local distance function can then be expressed by the following alternative standards:
dᵢⱼ=d(xᵢ, yⱼ)=|xᵢ−yⱼ|,
dᵢⱼ=d(xᵢ, yⱼ)=(xᵢ−yⱼ)², or
generally dᵢⱼ=d(xᵢ, yⱼ)=∥xᵢ, yⱼ∥ with ∥x, y∥ as metric.

The expression ∥x, y∥ is generally known from mathematics and satisfies the conditions ∥x, y∥+∥y, z∥≧∥x, z∥ (triangular inequality), ∥x, x∥=0, ∥x, y∥≧0 and ∥x, y∥=∥y, x∥ (symmetry).

As before, the cumulative distances are formed as the sum of the preceding local distances and the most favorable distortion path is determined recursively with the minimum condition. Once the distortion path has been defined, a corresponding characteristic point of the other ECG curve can be indicated for each characteristic point of one ECG curve.

During the determination of the optimum path the recursion formula defines which boxes can be reached in a recursion step. In accordance with the above formula, the minimum is determined from three different cumulative distances, the three distances being measured from one box to directly neighboring boxes. Alternatively, the following recursion matrix, resulting from the associated recursion formula, can be used:

$${D}_{ij} = \{ \begin{matrix}0 & i = j = 0 \\ min \{ {D}_{i , j - 1} , {D}_{i - 1 , j - 1} , {D}_{i - 2 , j - 1} \} + {d}_{ij} & i > 0 , j > 0 \\ ∞ & else\end{matrix}$$

In this case three cumulative distances are compared again, be it that the corresponding boxes are not direct neighbors in one of the three comparisons. The distances that are actually compared with one another in the recursion formula are dependent on the exact system conditions and can be varied, if desired, in conformity with the predetermined task by the back-pointers or local transitions given by the recursion formula.

The FIGS. 5 and 6 show a respective diagram of some local distances for two ECGs. For the sake of simplification, the signal values are rounded off (quantized) to the corresponding integer values with absolute values of between 0 and 10. There is a box for each characteristic point of the time axes t and the first characteristic points are denoted each time by x1 to x5 and y1 to y5. The local distances are calculated each time as dᵢⱼ=d(xᵢ, yⱼ)=|xᵢ−yⱼ|. The optimum path is determined by means of the cumulative distances (not shown here) and the recursion formula

$${D}_{ij} = \{ \begin{matrix}0 & i = j = 0 \\ min \{ {D}_{i - 1 , j - 1} , {D}_{i - 1 , j} , {D}_{i , j - 1} \} + {d}_{ij} & i > 0 , j > 0 \\ ∞ & else\end{matrix}$$

The two ECG curves E2 and E3 are substantially the same in FIG. 5, so that the optimum path, represented by boxes enclosed by heavy lines, extends as a diagonal. The ECG E4 in FIG. 6 exhibits slight non-linear distortions relative to the ECG E2. In zones in which the course of the two curves is approximately the same, the optimum path is practically diagonal. In zones in which the paths of the signal deviate, the optimum path deviates from the diagonal. When the optimum path has been defined, a corresponding instant x of the ECG E2 can be determined for each instant y of the ECG E4 and vice versa, the ECG curves then representing substantially the same state of motion of the heart at corresponding instants.

When the corresponding instants have been defined, FIG. 7 shows possibilities for selecting corresponding images in conformity therewith. During the acquisition of the ECG E5, the vessels of the heart are filled with a contrast medium and the image I51 is acquired at an instant t51. No contrast medium was used during the acquisition of the ECGs E6 and E7 and the associated image sequences. The similarity comparison with the ECG E6 yields the corresponding instant t63 at which the corresponding image I63, representing the same state of motion of the heart as the image I51, was acquired. The image I63 can be used for subtraction angiography. The similarity comparison with the ECG E7 yields a corresponding instant t75. However, no image was acquired at that instant as is illustrated by the dashed arrow at the instant t75. Prior to the corresponding instant t75 the image I72 was acquired and the image I73 was acquired after the instant t75.

A first possibility of obtaining an image which is suitable for subtraction angiography is to select that image whose acquisition instant lies as closely as possible to the corresponding instant t75. In other words, that image is selected for which the time difference between the acquisition instant of the image and the corresponding instant t75 is smallest. This would be the image I73. This possibility is used notably when there are further image sequences with ECGs (not shown) which have been acquired without using a contrast medium. For each of these further ECGs this method enables the determination of a time difference between the relevant corresponding instant and the nearest image. The image for which the time difference is smallest is chosen for subtraction angiography.

Another possibility for obtaining an image which is suitable for subtraction angiography is to interpolate an image from those images which have been acquired each time before and after the corresponding instant. For example, the motion of the heart between the states of motion shown in the images I72 and I73 can be interpolated so as to form an artificial image which represents the state of motion of the heart at the corresponding instant t75. In a simple case a linear motion of the heart is assumed between the states of motion of the images I72 and I73. In another case the overall motion of the heart is described in a motion model whereby the almost exact motion of the heart between the acquisition instants of the images I72 and I73 can be interpolated and an image of the state of motion at the corresponding instant t75 can be determined.

The use of the method in accordance with the invention is not limited to one reference image. In the case of an image sequence comprising a plurality of reference images, a corresponding image can be determined or formed for each individual reference image by means of the method.

FIG. 8 is a diagrammatic representation of a medical X-ray examination system. The system includes an X-ray source 40 which is arranged to emit X-rays 42 in such a manner that they traverse an object to be examined, in this case being a patient 41 who is arranged on a table 43 which is transparent to X-rays; subsequently, the X-rays can be detected by an X-ray image detector 44 which is arranged underneath the table 43. The X-ray image detector 44 comprises an array of sensor elements which are sensitive to X-rays. Because of the organ-specific attenuation of the X-rays 42 while traversing the patient 41, an image is formed in the X-ray image detector 44, the data of said image being applied to a data processing unit 46. The data processing unit 46, also being capable of executing system control tasks which are not described herein, processes the incoming image data 45 in such a manner that an optimum image is formed for a viewer. The image data 47 thus processed is applied to a visualization unit 48, for example, a monitor, on which the data can be presented to a viewer. The data processing unit can optionally be constructed so as to be programmable. In that case a data reading apparatus 52 is available which is coupled to the data processing unit 46 and is capable of reading a computer program from a computer program product so as to apply it to the data processing unit 46. The computer program enables the data processing unit inter alia to carry out the method in accordance with the invention.

Electrodes which are connected to an ECG apparatus 51 are attached to the patient. The Figure shows, merely by example, only one connection lead 50 with an electrode attached to the body. In reality a plurality of electrodes will be used in known manner as well as an electrode (not shown) for a reference potential (often ground). The ECG apparatus connected to the data processing unit 46 forms the ECG of the patient 41 during the X-ray image acquisition under the control of the data processing unit 46, and presents it to the data processing unit 46 in order to carry out the method in accordance with the invention.

Also shown is a catheter 49 which is typically introduced into a blood vessel in the region of the groin of the patient during cardiological examinations. The physician then advances the tip of the catheter as far as the heart while acquiring X-ray image sequences with a low dose which serve as an aid for the navigation within the body. Once the heart is reached, via the catheter contrast medium is injected into the blood vessels of the heart. Briefly before the emergence of the contrast medium from the tip of the catheter the X-ray image detector 44 and the X-ray source 40 are switched to a high-dose mode of operation for the subsequent acquisitions, so that detailed high-dose images are formed of the vascular tree of the heart which is filled with the contrast medium.

Subsequently, the X-ray source is deactivated or low-dose images are formed again should the physician require navigation aids for further actions. The high-dose images of the vascular tree filled with the contrast medium are stored in the data processing unit 46. Using the ECG formed by the ECG apparatus 41 and the method in accordance with the invention, these high-dose images can be superposed in the described manner on the low-dose images or on further high-dose images, representing the vascular tree without contrast medium, so as to be presented to the physician by way of the visualization unit 48.

The method in accordance with the invention can be used for various cardiological examinations.
1. A plurality of cardiac cycles of the beating heart is acquired without injection of a contrast medium. Subsequently, a few cardiac cycles are acquired, or only a single cardiac cycle, with a contrast medium and subsequently a few cardiac cycles again without the contrast medium. After a respective image without contrast medium has been determined for several or all images of a cardiac cycle, which images represent the heart filled with the contrast medium, by means of the method in accordance with the invention, and after its subtraction therefrom, there is obtained the image sequence of a cardiac cycle in which the images represent substantially exclusively the vascular tree of the heart in the various states of motion of a cardiac cycle. These images are stored in a data processing unit and can be repeatedly presented to a physician as a moving image sequence. The images with the contrast medium then constitute the reference images and the images without the contrast medium form the corresponding images.
2. The data processing unit of an examination system contains an image sequence as formed in the above section 1, its images representing practically exclusively the vascular tree of the heart in the various states of motion of a cardiac cycle. In order to position a catheter near the heart, the physician utilizes an aid for navigation in the body in the form of X-ray image sequences which are acquired continuously with a low dose. In these sequences the vascular tree and the heart can be recognized only with difficulty because of the physical conditions. For an X-ray image just acquired a corresponding image is automatically or manually determined from the stored sequence so as to be superposed on the X-ray image by means of the method in accordance with the invention. As a result, the vascular tree filled with the contrast medium is superposed on the instantaneous X-ray image so that the physician is offered a suitable navigation aid. If desired, such superposition can also be performed continuously for practically every acquired X-ray image. The images without the contrast medium then form the reference images and the images with the contrast medium form the corresponding images.

It is to be noted that the method is not restricted to X-ray examination systems. The method in accordance with the invention can be carried out in an ultrasound examination system in the same way as in the X-ray examination apparatus shown in FIG. 8. To this end, the reference images and the corresponding images are formed by ultrasound, an ultrasound-reflecting contrast medium being administered to the vessels or the tissue to be examined either during the acquisition of the reference images or of the corresponding images.

1. A method of determining a corresponding image for a reference image from an image sequence of a moving object by means of a first and a second motion signal, in which
the first and the second motion signal represent the respective variation in time of the states of motion of a first motion and a second motion of the object,
the image sequence represents the first motion of the object as a sequence of images of states of motion,
the reference image represents a state of motion from the second object motion and is acquired at a reference instant during the second motion of the object,
including the following steps:
a. determining a similarity function by way of a similarity comparison of the first and the second motion signal,
b. determining a correspondence instant in the first motion signal by means of the similarity function, the correspondence instant corresponding to the acquisition instant of the reference image from the second motion signal,
c. determining, using the first motion signal, that image of the image sequence whose acquisition instant corresponds at least approximately to the correspondence instant.

2. A method as claimed in claim 1, characterized in that the similarity function is obtained by means of the so-called dynamic time warping method.

3. A method as claimed in claim 1, characterized in that an interpolation image is formed from the corresponding image and a further image from the image sequence, which interpolation image represents at least substantially the state of motion of the object at the correspondence instant.

4. A method as claimed in claim 1, characterized in that the first and the second motion signal form an electrocardiographic signal and that the images of the image sequence and the reference image represent states of motion of a human or animal heart.

5. A method as claimed in claim 4, characterized in that the blood vessels of the heart are filled at least partly with a contrast medium either in images of the image sequence or in the reference image.

6. A method as claimed in claim 1, characterized in that the image sequence forms an X-ray image sequence and/or the reference image forms an X-ray image.

7. A method as claimed in claim 1, characterized in that the image sequence and/or the reference image forms an ultrasound image.

8. A system which includes a data processing unit for determining a corresponding image of a moving object for a reference image from an image sequence by means of a first and a second motion signal, the data processing unit being arranged to carry out a method as claimed in claim 1.

9. An examination apparatus which includes an X-ray image detector and means for the detection of electrocardiographic signals, which apparatus includes a system as claimed in claim 8.

10. A computer program or computer program product which is arranged to co-operate with a data processing unit in such a manner that the data processing unit is capable of carrying out a method as claimed in claim 1.
